(19) United States
(12) Patent Application Publication
(10) Pub. No.: US 2013/0325649 A1
(43) Pub. Date: Dec. 5, 2013

(54) METHOD AND SYSTEM FOR AUTOMATIC LEGAL DOCUMENT PREPARATION BY CONSUMER OVER THE INTERNET

(71) Applicant: Legal Arrow Inc., Orange, CA (US)

(72) Inventor: Marin P. Cionca, Orange, CA (US)

(21) Appl. No.: 13/908,859

(22) Filed: Jun. 3, 2013

Related U.S. Application Data
(60) Provisional application No. 61/655,343, filed on Jun. 4, 2012.

(51) Int. Cl. G06Q 50/18

(52) U.S. Cl. CPC G06Q 50/18; G06Q 30/0621
USPC 705/26.5

(57) ABSTRACT

A system comprising at least one networked computer configured to perform in any order the following functions: receiving from a provider computer at least one electronic document set comprising a document specific questionnaire, a questionnaire specific guide, a document specific legal form and a specific legal document use guide; receiving from a user computer a legal document order comprising answers to the document specific questionnaire and payment; preparing a specific legal document based on the document specific legal form and the answers received; and, if payment is successful, immediately sending the prepared specific legal document by email to the user.

### CROSS-REFERENCE TO RELATED APPLICATIONS

This application claims the benefit of U.S. Provisional Application No. 61/655,343 filed Jun. 4, 2012, which is hereby incorporated by reference, to the extent that it is not conflicting with the present application.

### BACKGROUND OF THE INVENTION

1. Field of the Invention

The invention relates generally to internet technology and more particularly to an automatic system and method for automatic legal document preparation by consumer over the internet.

2. Description of the Related Art

Today, legal document preparers, independent paralegals, and so on, may, at least in some states, prepare legal documents for consumers at consumers' direction, and following state rules prohibiting the offering of legal advice by a non-lawyer. Typically, a consumer walks into such office, expresses interest in a certain legal document, and the preparer uses a legal form to manually, or by using a computer, fill it out based on the information collected from the consumer. Lately, the internet was used to allow the consumers to place orders online, after which a preparer will prepare the document and will then send it to the consumer by mail or email. While the online approach is an improvement, still a real person has to prepare the document and send it to the consumer, and that means that the process is still very expensive and slow too. Others appear to have tried to eliminate the real person from the process through web applications that seem complicated and expensive. Further, for example, the choices offered by these applications to the consumers, to customize their documents based on relative strength of legal provisions (rating system), appear to be inexistent.

Thus, there is a need for new and improved method and system, that are fast and inexpensive, that automate the process of legal document preparation, and that provide more adequate legal document customization options using internet technology.

### BRIEF SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In one exemplary embodiment a consumer, over the internet, selects a legal document she needs prepared, answers a few questions, pays for the legal document, and receives by email immediately the legal document she wanted prepared based on her answers. She can then print the document and use as she wishes. Thus, an advantage is the rapidity of the process. The consumer gets the prepared document immediately when she needs it, without any delay. This is obviously very convenient to the consumer. Because no real person is involved at the other end, the cost for providing the service is low and the savings are passed on to the consumer. And this is another considerable advantage.

In another embodiment, relative strength of legal provisions is provided through a rating system. Thus, an advantage is that users have more adequate options for customizing their legal document.

The above embodiment and advantages, as well as other embodiments and advantages, will become apparent from the ensuing description and accompanying drawings.

### BRIEF DESCRIPTION OF THE DRAWINGS

For exemplification purposes, and not for limitation purposes, embodiments of the invention are illustrated in the figures of the accompanying drawings, in which:

FIG. 1 shows a schematic diagram of a method for automatic legal document preparation by consumer over the internet, according to an embodiment.

FIG. 2 is a flow chart depicting the preparatory steps needed to be performed in order to make available the method for automatic legal document preparation by consumer over the internet.

FIG. 3 is a flow chart depicting the typical steps of the method for automatic legal document preparation by consumer over the internet.

### DETAILED DESCRIPTION OF THE PREFERRED EMBODIMENTS

What follows is a detailed description of the preferred embodiments of the invention in which the invention may be practiced. Reference will be made to the attached drawings, and the information included in the drawings is part of this detailed description. The specific preferred embodiments of the invention, which will be described herein, are presented for exemplification purposes, and not for limitation purposes. It should be understood that structural and/or logical modifications could be made by someone of ordinary skills in the art without departing from the scope and essence of the invention.

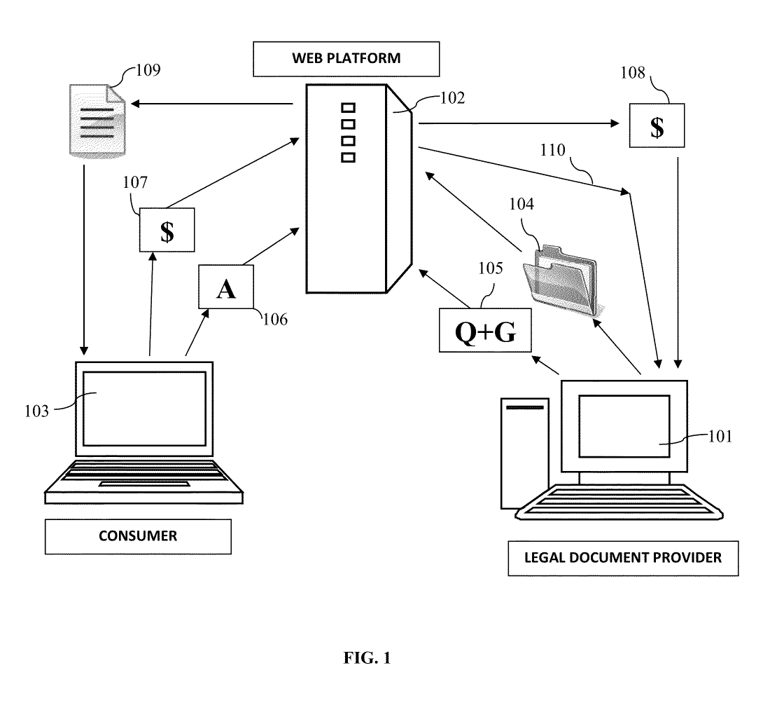

FIG. 1 shows a schematic diagram of a method for automatic legal document preparation by consumer over the internet (“method”; “automatic method”), according to an embodiment. A legal document provider 101, such as a legal document preparer (e.g., a legal document assistant (LDA) in California) may automate its services, by creating a web platform 102 capable of performing the tasks normally performed by a real person (e.g., an employee) providing legal document services, as well as other additional tasks that may not be normally performed by a real person. That is, among other things, as it will be explained in details herein, to use the appropriate legal form and include in it the information provided by the client/consumer 103 in order to obtain a prepared, ready-to-sign and use legal document by the consumer. The legal document provider may prepare the legal forms used itself, or, especially if the laws so require, the legal forms used may need to be prepared by a separate and appropriate party (e.g., an attorney or law firm), not shown.

The web platform 102 may be a computer/server or a network of computers/servers which are programmed to perform the steps of the method described herein.

The legal document provider 101 uploads to the web platform 102 the legal forms and the associated consumer legal document use guides (see 104, FIG. 1). The legal document provider 101 also uploads an especially designed online questionnaire “Q” (e.g., as a web form) and a questionnaire guide “G” (see 105, FIG. 1) for each legal document. A consumer 103, having a computer with internet access, and being interested in preparing a legal document using the automated method described herein submits answers 106 to the specific questionnaire 105/Q, with the help of the questionnaire guide 105/G to the platform 102, and payment 107. The web platform 102 uses the appropriate legal form 104 and the consumer answers 106 to prepare and send to the consumer 103, preferably by email, the prepared legal document and the associated document use guide 109. Next, the legal document provider 101 receives, preferably also by email, from the web platform 102 a record/confirmation of the order/transaction 110 and/or payment 108. The entire process may take just a few minutes, without any real person involved, except for the consumer. This means that the costs associated with providing the service are very low and the savings are passed on to the consumer 103. In addition, the consumer 103 may obtain a fully prepared legal document 109 when she wishes, without any wait or delay. Furthermore, because the legal document is already prepared and ready-to-sign, the consumer does not need to struggle with trying to figure out how to complete an empty legal form.

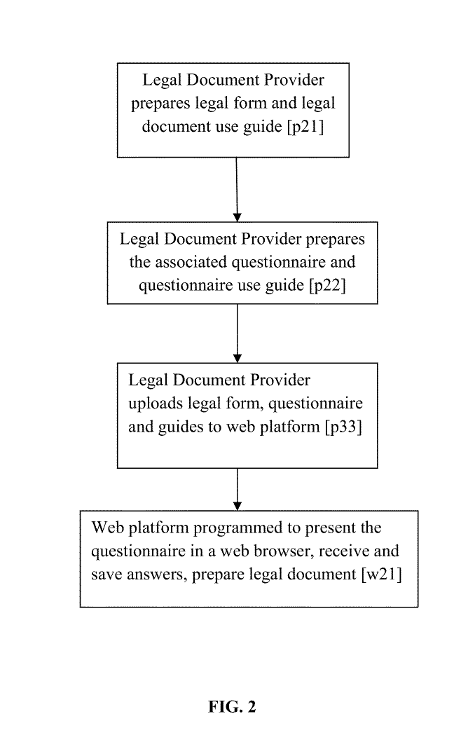

FIG. 2 is a flow chart depicting the preparatory steps needed to be performed in order to make available the method for automatic legal document preparation by consumer over the internet. There is considerable amount of preparatory work that needs to be done in order to be able to offer the automatic method over the internet. In step p21, the legal document provider, or an engaged third party, needs to prepare the legal form and the associated legal document use guide for each legal document to be provided (e.g., a limited power of attorney).

When preparing the legal form, an expert, such as a lawyer, needs to carefully decide which portions of the legal document should be allowed to be editable/customized by the web platform based on consumer's answers, and which portions should be unchangeable, if any, because, for example, standard language required by law. For a simple to use automatic method, obviously, the goal should be to leave as editable as few document portions as possible. For example, in the case of a limited power of attorney, the name and address of the principal, the name and address of the attorney-in-fact, the authorization description and the validity dates may be enough to be left as editable and thus customizable by the web platform base on consumer's answers.

The legal document use guide and the corresponding legal form, and/or later the prepared document, may be together included in a single multi-page document with the guide preferably starting on the first page. The legal document use guide may include information for the consumer on how to review the prepared legal document, how to make it legal (e.g., “notarization required”), how and/or where to file it, and so on.

In step p22, a unique questionnaire and a corresponding questionnaire guide have to be prepared for each specific legal document (e.g., limited power of attorney, trademark registration application, etc) and particularly with its editable portions in mind. Each editable portion will usually have one or more corresponding questions in the questionnaire designed to elicit the necessary information from the consumer. Typically, to answer the question(s), the consumer may be prompted to select from a set of answer choices (e.g., “yes” or “no”, “delegation is allowed” or “delegation is not allowed,” etc), or she may be allowed to enter her answer in free text boxes.

The questionnaires may be web forms capable of sending the answers to a server, preferably in a secure way via a SSL certificate. The web platform needs to be configured to associate the answer provided by the consumer in the questionnaire with the corresponding editable portion in the legal document. That can be done, for example, by assigning a unique ID to each answer field in the questionnaire and a corresponding unique ID to each editable portion of the document. The web platform may then track the two sets of IDs, match them up and use this information to create/assemble the final legal document.

It should be noted that for what may probably be the simplest configuration of the web platform, the editable portions of the document may be empty spaces in the legal form in which the information from the consumer/user (e.g., name of the consumer, authorization description (i.e., when a limited power of attorney is prepared), etc) is inserted by the web platform. However, it should be also noted that more sophisticated approaches/algorithms are preferred, and thus, may be implemented, for, for example, creating complicated legal documents and/or to give more options to the user/consumer. For example, the consumer may be asked whether or not to include a certain provision in a document (e.g., third party indemnification provision in a limited power of attorney). Or, variations of certain or all provisions may be presented to the consumer to choose from. These provision variations may also be rated/labeled (e.g., strong, medium, weak) to assist the consumer in choosing them. For example, a strong indemnification provision in a limited power of attorney could be one through which the principal promises to indemnify a third party relying on the power of attorney for a large array of acts performed by her appointed attorney-in-fact. Furthermore, an option may be given to the consumer to edit these provision variations as the consumer sees them on the screen and/or later when the document is delivered to the consumer (e.g., by delivering the document in a .doc format). Obviously, if the automated method is offered by a non-attorney, care needs to be exercised so that the options or rating/labeling, and anything else, do no amount to legal advice.

The questionnaire may also include browse/upload buttons so that the consumer may upload items such as images, so that they are assembled in the final document. This feature may be important for, for example, documents such as a drawing/specimen sheet of a trademark application or a drawing sheet of a provisional application for patent. The trademark specimen or the patent figures may be uploaded as images and the web platform may position the images in the right place in the final document.

The questionnaire guide is designed to assist the consumer with the completion of the questionnaire and may include explanations about what the purpose of the question(s) is, definitions of terms, and so on. For example, in a power of attorney situation, the definition of the attorney-in-fact may be included. The questionnaire guide may also include examples of answers, to assist the consumer in filling out the questionnaire. For example, besides the definition of the authorization given in a power of attorney, one or more examples may also be provided such as, “authorization to register my car, 2009 Mercedes E350, license plate . . . ,” “authorization to deposit my social security check into my bank account number . . . ,” and so on.

In step p33 (FIG. 2), the legal form and corresponding legal document use guide and the questionnaire and the corresponding questionnaire guide are uploaded to the web platform.

In step w21, a web programmer/developer programs the web platform to, typically, do the following: present the consumer with the available documents that can be prepared through the automated method; allow the consumer to select the document desired; present/display to the consumer the appropriate questionnaire and questionnaire guide; receive and save the answers entered by the consumer; prepare the legal document based on the appropriate legal form previously uploaded by the legal document provider, and, after ensuring that the appropriate payment was submitted electronically by the consumer, deliver the prepared legal document and the corresponding legal document use guide to the consumer preferably by email. As a web programmer knows, database(s) to store the answers entered into the questionnaire by the consumer, order/transaction ID, payment ID received from shopping cart, and/or other tracking IDs, folders to store the prepared documents, and so on are needed to make the automatic method work. The payment may be processed through a shopping cart that may be integrated into the web platform or through an external shopping cart such as PayPal shopping cart.

While other approaches may be used, such as the option to download instead the final prepared document, the delivery of the prepared legal document to the consumer by the web platform may be preferably done by email (preferably as .pdf attachment) as the email approach presents considerable advantages. For example, no registration into the web platform and creation of login is necessary, and thus, the consumer can access the created legal document at any time from her email account without the need to return to and login into the web platform. In addition, in the same email, the consumer may typically and preferably receive the order summary including the answers she submitted. Thus, by accessing his email one time after using the web platform, the consumer can quickly review her order summary, the answers submitted and the prepared legal document received. Should an error be detected in her answers, the consumer may conveniently click on a link provided in the same email to access the web platform and retrieve her answers by entering in the provided interface, preferably, only her email address and/or transaction/order ID. Then, she can edit her answers and the web platform will send her the updated document and/or a copy of the updated answers.

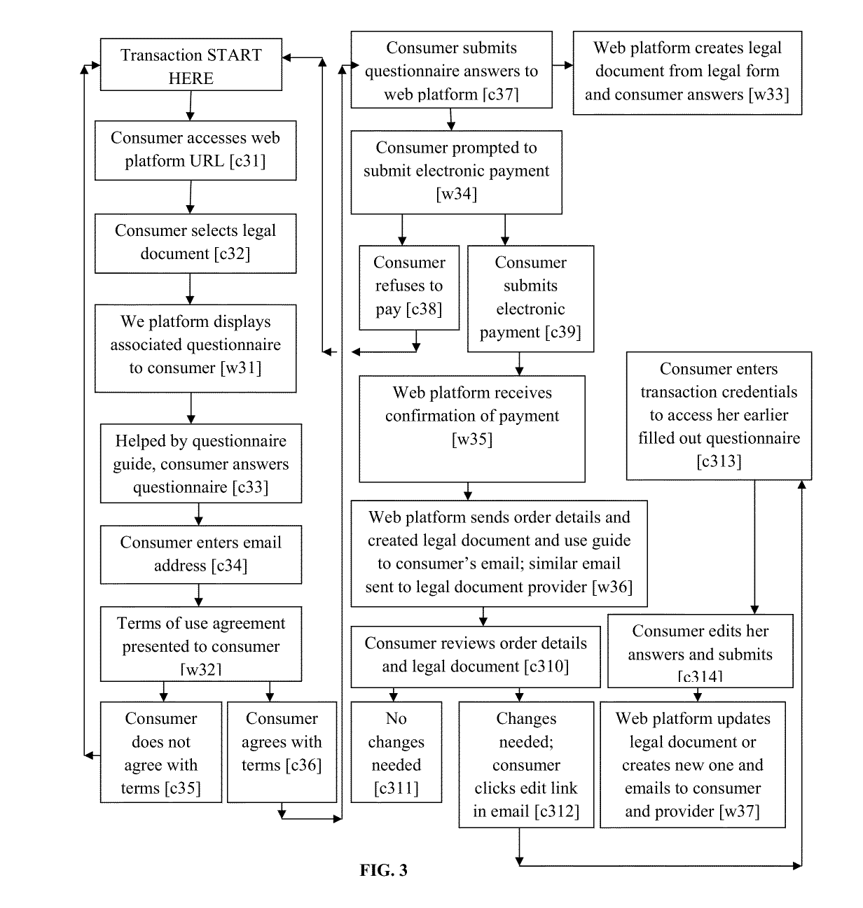

FIG. 3 is a flow chart depicting the typical steps of the method for automatic legal document preparation by consumer over the internet.

As shown in FIG. 3, the consumer first accesses the web platform's URL (Step c31) and then selects the legal document desired (c32) from a list presented/displayed to her by the web platform. Once a legal document is chosen, the web platform displays the corresponding questionnaire (w31) for the consumer to fill out. Next, helped by the corresponding questionnaire guide, the consumer fills out the questionnaire (Step c33). The consumer is also prompted to enter his email address in one of the questionnaire's fields (c34) and to agree to the terms of use agreement (w32). The web platform may be programmed to stop the automatic method/process (c35) and send the consumer to the starting screen if the consumer does not agree with the terms of use. If the consumer agrees with the terms of use agreement (c36), she is allowed to continue the process. Typically, next, the consumer submits her answers (c37) to the web platform. The web platform will store the answers, in, for example, a database, will generate/prepare and save the legal document, and assign an order/transaction ID to the order. Next, the consumer is prompted to submit electronic payment (w34) for the selected legal document, via an internal or external shopping cart (e.g., PayPal). If the consumer refuses to pay or if the electronic payment transaction fails to complete (c38) the process is typically stopped and the consumer may be sent back to the start page, or, another page indicating that the order may not be placed at this time may be displayed. If payment is submitted successfully (c39), the web platform receives confirmation of payment from the shopping cart (w35) and sends an email to consumer (w36) and to the legal document provider, which may include order summary (including answers submitted), preferably in the body of the email, and the prepared document and the document use guide, preferably as an attached single multi-page document in .pdf format.

Next (c310), consumer reviews order details and legal document. If no changes are needed, the process stops here (c311). If changes are needed (c312), the consumer may click in a link provided in the same email to access the web platform, which may be programmed to allow the consumer to edit her answers and generate an updated document reflecting her new answers within a set period of time (e.g., 48 hours), free of charge. Next (Step c313), the consumer is asked to enter her transaction credentials (e.g., transaction/order ID), which she has received in the email, and, typically, or alternatively, also her email address previously entered/used. Of course, if a login was initially required/created, same login credentials may be elicited now. If the entry(-ies) is/are correct, the web platform displays the previously filled out questionnaire with the respective answers filled in.

Next, (c314), the consumer reviews her previously entered answers and edits them as needed. When done, the consumer submits the updated answers to the web platform (c314). Finally, (step w37), the web platform updates the previously generated document or creates a new one and emails it to the consumer, and preferably together with a copy of the new answers and the same link to use if further editing becomes necessary. A copy of the email is again also sent to the legal document provider and/or web platform operator (if different) for, for example, record and administration purposes.

Optionally or alternatively, besides emailing the prepared legal document to the consumer in a popular and easy to print format (e.g., .pdf), the prepared legal document may also be delivered in other popular format(s) (e.g., .doc format) for the consumer to be able to use a readily available word processor (e.g., Microsoft Word), or other editing programs, in order to edit the document on her computer as needed.

It may be advantageous to set forth definitions of certain words and phrases used in this patent document. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the invention. Therefore, the scope of this application is intended to cover alternate embodiments and/or equivalent variations of the specific embodiments illustrated and/or described herein.

What is claimed is:

1. A system comprising at least one networked computer configured to perform in any order the following functions: receiving from a provider computer at least one electronic document set comprising a document specific questionnaire, a questionnaire specific guide, a document specific legal form and a specific legal document use guide; receiving from a user computer a legal document order comprising answers to said document specific questionnaire and payment; preparing a specific legal document based on said document specific legal form and said answers; and, if payment is successful, immediately sending the prepared specific legal document by email to the user.

2. The system from claim 1, further configured to receive requests from the user to amend the prepared specific legal document and to immediately process such requests and send by email an amended specific legal document to the user.

3. The system from claim 2, wherein the system is configured to receive requests from the user to amend the prepared specific legal document only within a predetermined period of time after the sending of the prepared specific legal document by email to the user.

4. The system from claim 1, wherein the specific legal document is a limited power of attorney.

5. The system from claim 1, wherein the document specific legal form is static, such that it contains standard legal provisions that cannot be modified, replaced or deleted by the user, and wherein the user's answers are used only to be placed in previously left empty spaces in the document specific legal form.

6. The system from claim 1, wherein the document specific legal form is dynamic, such that for at least one legal provision from the document specific legal form, a plurality of provision choices is provided to the user, and wherein, after the user selects one of the plurality of provision choices, the selected provision choice is included in the document specific legal form.

7. The system from claim 6, wherein the provision choices are rated, such that to aid the user with the selection of one of them.

8. The system from claim 7, wherein at least one provision choice can be edited by the user in real time.

9. The system of claim 1, wherein said answers comprise at least one image uploaded by the user for inclusion in the prepared specific legal document.

10. A method for automatic legal document preparation by consumer over the internet, performed using at least one networked computer, and comprising in any order: receiving from a provider computer at least one electronic document set comprising a document specific questionnaire, a questionnaire specific guide, a document specific legal form and a specific legal document use guide; receiving from a user computer a legal document order comprising answers to said document specific questionnaire and payment; preparing a specific legal document based on said document specific legal form and said answers; and, if payment is successful, immediately sending the prepared specific legal document by email to the user.

11. The method from claim 10, further comprising, accepting requests from the user to amend the prepared specific legal document, immediately processing such requests and sending by email an amended specific legal document to the user.

12. The method from claim 11, wherein accepting requests from the user to amend the prepared specific legal document only occurs within a predetermined period of time after the sending of the prepared specific legal document by email to the user.

13. The method from claim 10, wherein the specific legal document is a limited power of attorney.

14. The method from claim 10, wherein the document specific legal form is static, such that it contains standard legal provisions that cannot be modified, replaced or deleted by the user, and wherein the user's answers are used only to be placed in previously left empty spaces in the document specific legal form.

15. The method from claim 10, wherein the document specific legal form is dynamic, such that for at least one legal provision from the document specific legal form, a plurality of provision choices is provided to the user, and wherein, after the user selects one of the plurality of provision choices, the selected provision choice is included in the document specific legal form.

16. The method from claim 15, wherein the provision choices are rated, such that to aid the user with the selection of one of them.

17. The method from claim 15, wherein at least one provision choice can be edited by the user in real time.

18. The method of claim 10, wherein said answers comprise at least one image uploaded by the user for inclusion in the prepared specific legal document.

19. A processor based method for automatic legal document preparation by consumer over the internet comprising providing a rating system for legal provisions available for inclusion in the legal document.
